(19) United States
(12) Patent Application Publication
(10) Pub. No.: US 2025/0037110 A1
(43) Pub. Date: Jan. 30, 2025

(54) DATA PROCESSING METHOD AND SYSTEM, AND TERMINAL AND COMPUTER-READABLE STORAGE MEDIUM

(71) Applicant: ZTE CORPORATION, Shenzhen (CN)

(72) Inventors: Xiaoliang LI, Shenzhen (CN); Guotao QU, Shenzhen (CN); Jie GAO, Shenzhen (CN); Kaihua HUANG, Shenzhen (CN); Chenhui LI, Shenzhen (CN); Xiangxin MEI, Shenzhen (CN); Qi WANG, Shenzhen (CN); Peng DENG, Shenzhen (CN)

(21) Appl. No.: 18/696,677

(22) PCT Filed: Jun. 17, 2022
(86) PCT No.: PCT/CN2022/099524

§ 371 Date: Mar. 28, 2024

(30) Foreign Application Priority Data
Sep. 28, 2021 (CN) 202111144004.3

(51) Int. Cl. G06Q 20/34; G06K 7/10; G06Q 20/32

(52) U.S. Cl. CPC G06Q 20/352; G06K 7/10237; G06Q 20/3224

(57) ABSTRACT

A data processing method and system, a terminal device, and a computer-readable storage medium are disclosed. The data processing method may include: detecting whether a first terminal device enters a Radio Frequency (RF) field, the first terminal device has enabled a Near Field Communication (NFC) function, the first terminal device is provided with an RF card, and the RF card is configured for making a payment via the RF field; reading a payment record of the RF card in response to the first terminal device entering the RF field and leaving the RF field within a preset time; and sending the payment record to a second terminal device.

### CROSS-REFERENCE TO RELATED APPLICATION

This application is a national stage filing under 35 U.S.C. § 371 of international application number PCT/CN2022/099524, filed Jun. 17, 2022, which claims priority to Chinese patent application No. 202111144004.3, filed Sep. 28, 2021. The contents of these applications are incorporated herein by reference in their entirety.

### TECHNICAL FIELD

Embodiments of the present disclosure relate to the field of Internet technologies, and more particularly, to a data processing method and system, a terminal device, and a computer-readable storage medium.

### BACKGROUND

With the rapid development of communication technologies, Near Field Communication (NFC) has been gradually applied. NFC is a short-distance high-frequency wireless communication technology that enables simple and secure two-way interaction between a plurality of electronic devices. NFC technology evolves from the integration of a contactless Radio Frequency Identification (RFID) technology and an interconnection technology, can implement functions of an inductive card reader, an inductive card, and point-to-point communication on a single chip, allowing the chip to identify and exchange data with compatible devices over a short distance.

A terminal device equipped with NFC technology has the capability to emulate a physical Radio Frequency (RF) card. This means the terminal device can act as a physical RF card, such as an access control card, a bank card, or a public transportation card. To make a transaction, a user only needs to put the terminal device simulating the physical RF card near a card reader and enter a password to confirm the transaction, or only needs to swipe the card directly.

However, there are several limitations to the emulation of physical RF cards by terminal devices with NFC technology. For example, the operator of the physical RF cards or the Point of Sales (POS) terminals manufacturer may not allow such devices to emulate physical RF cards. As a result, the terminal device cannot act as a physical RF card, and the terminal device's owner must use the actual RF card for payments. Since data processing involving physical RF cards can be delayed, users are unable to immediately access their payment records via the terminal device. This delay is particularly problematic for an elderly or a child using the physical RF card, as it prevents real-time monitoring of their transactions.

### SUMMARY

Embodiments of the present disclosure provide a data processing method and system, a terminal device, and a computer-readable storage medium.

An embodiment of the present disclosure provides a data processing method, including: detecting whether a first terminal device enters an RF field, where the first terminal device has enabled an NFC function, the first terminal device is provided with an RF card, and the RF card is configured for making a payment via the RF field; reading a payment record of the RF card in response to the first terminal device entering the RF field and leaving the RF field within a preset time; and sending the payment record to a second terminal device.

An embodiment of the present disclosure provides a data processing system, including a first terminal device, an RF card, and a second terminal device, where the first terminal device is provided with the RF card; the first terminal device is configured for detecting whether the first terminal device enters an RF field, reading a payment record of the RF card in response to the first terminal device entering the RF field and leaving the RF field within a preset time, and sending the payment record to the second terminal device; the RF card is configured for making a payment via the RF field in response to the first terminal device entering the RF field and leaving the RF field within the preset time; and the second terminal device is configured for receiving the payment record sent by the first terminal device.

An embodiment of the present disclosure further provides a terminal device, including: at least one processor; and a memory communicably connected to the at least one processor, wherein the memory stores instructions executable by the at least one processor which, when executed by the at least one processor causes the at least one processor to carry out the above data processing method.

An embodiment of the present disclosure provides a computer-readable storage medium, storing a computer program which, when executed by a processor, causes the processor to carry out the above data processing method.

### BRIEF DESCRIPTION OF DRAWINGS

FIG. 1 is a flowchart one of a data processing method according to an embodiment of the present disclosure;

FIG. 2 is a side view one of a first terminal device according to an embodiment of the present disclosure;

FIG. 3 is a side view two of a first terminal device according to an embodiment of the present disclosure;

FIG. 4 is a rear view of a first terminal device according to an embodiment of the present disclosure;

FIG. 5 is a flowchart two of a data processing method according to another embodiment of the present disclosure;

FIG. 6 is a flowchart of monitoring a location of a second terminal device according to another embodiment of the present disclosure;

FIG. 7 is a flowchart three of a data processing method according to another embodiment of the present disclosure;

FIG. 8 is a flowchart four of a data processing method according to another embodiment of the present disclosure;

FIG. 9 is a schematic diagram of a data processing system according to another embodiment of the present disclosure; and

FIG. 10 is a schematic structural diagram of a terminal device according to another embodiment of the present invention.

### DETAILED DESCRIPTION

Technical schemes and advantages of the embodiments of the present disclosure will be clear from a detailed description of the embodiments of the present application in conjunction with the drawings. However, it may be understood by those having ordinary skills in the art that many technical details are provided in various embodiments of the present application to make readers better understand the present disclosure. The technical schemes claimed in the present application can be realized even without these technical details and various variations and modifications made based on the following embodiments. The following embodiments are divided for convenience of description and are not intended to constitute any limitation on the specific implementations of the present application. The embodiments may be combined or used as references for each other where there are no contradictions.

An embodiment of the present application relates to a data processing method, which is applied to a terminal device. Implementation details of the data processing method of this embodiment will be described below and the following contents are provided only for convenience of understanding and are not necessary for implementing the present scheme.

In the embodiments of the present application, the terminal device may be a mobile phone, a tablet computer, a smart watch, smart glasses, a smart band, etc., supporting an NFC function. This embodiment and the following embodiments are described using a smart phone supporting the NFC function as an example.

FIG. 1 shows a detailed process of the data processing method of this embodiment, which includes the following steps 101 to 103.

At step 101, it is detected whether a first terminal device enters an RF field, where the first terminal device has enabled an NFC function.

At step 102, a payment record of an RF card is read when the first terminal device enters the RF field and leaves the RF field within a preset time.

In an implementation, the NFC function of the first terminal device may be enabled all the time to detect in real time whether the first terminal device enters the RF field. When the first terminal device detects that it enters the RF field and leaves the RF field within the preset time, the first terminal device reads the payment record of the RF card. The preset time may be set by those having ordinary skills in the art according to actual needs, which is not particularly limited in the embodiments of the present disclosure.

In an embodiment, the first terminal device is provided with the RF card, the RF card provided in the first terminal device is a physical RF card, a card slot is provided on an inner side or an outer side of a back housing of the first terminal device, and the card slot is configured for fixing the RF card. The card slot is generally arranged at a position close to an NFC antenna of the first terminal device. The physical RF card may be a subway card, a bus card, a campus card, etc., which is not particularly limited in the embodiments of the present disclosure.

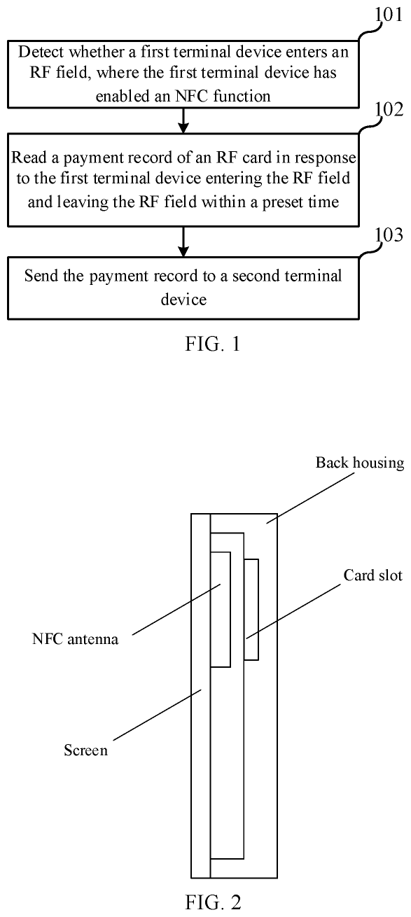

FIG. 2 is a side view of the first terminal device when the card slot is provided on the inner side of the back housing of the first terminal device. In an example, as shown in FIG. 2, the position of the card slot corresponds to the position of the NFC antenna.

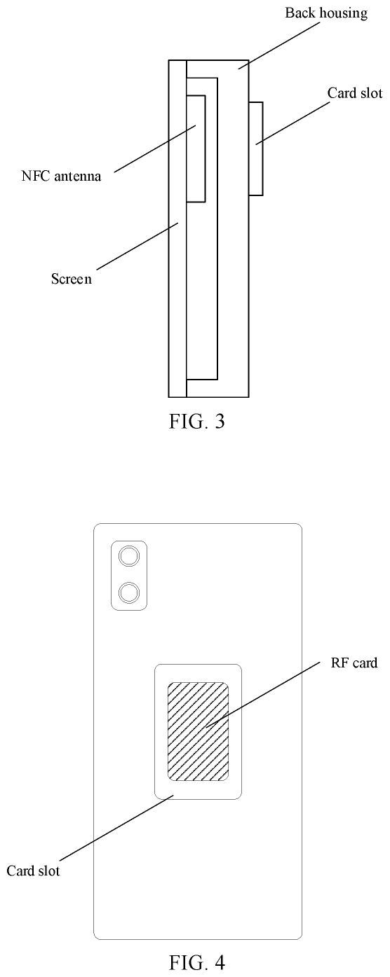

FIG. 3 is a side view of the first terminal device when the card slot is provided on the outer side of the back housing of the first terminal device, and FIG. 4 is a rear view of the first terminal device when the card slot is provided on the outer side of the back housing of the first terminal device. In an example, as shown in FIG. 3 and FIG. 4, the position of the card slot corresponds to the position of the NFC antenna, and the RF card is fixed in the card slot.

In an example, a card clip may be arranged on the outer side of the back housing of the first terminal device, the card clip is configured for fixing the RF card, and a position of the card clip corresponds to the position of the NFC antenna.

In an embodiment, when the RF card is in an RF field, the RF card may perform a payment activity via the RF field. In practice, the RF field may be generated by a device such as a subway automatic gate machine, a bus card reader, or a POS machine, or may be generated by a wireless charger based on an RF charging technology. It can be understood that the RF card can perform a payment activity in the RF field generated by a device such as the subway automatic gate machine, the bus card reader, or the POS machine, but cannot perform a payment activity in the RF field generated by the wireless charger. Therefore, in this embodiment, it may need to be determined whether the first terminal device leaves the RF field within a preset time after entering the RF field. The preset time may be set to be short, for example, 10 seconds. If the first terminal device determines that it enters the RF field and leaves the RF field within 10 seconds, the first terminal device may determine that the RF field is generated by a device such as the subway automatic gate machine, the bus card reader, or the POS machine, and the RF card has performed a payment activity. The first terminal device reads a payment record of the RF card. In this way, it can be determined more accurately whether the RF card performs a payment, to better meet the actual needs of the user.

In an embodiment, if the first terminal device does not detect its entry into the RF field, the first terminal device may remain in the detection state, until the first terminal device detects its entry the RF field.

In an example, the first terminal device may detect according to an identification message whether the first terminal device enters the RF field. The identification message at least includes an RF_FIELD_INFO_NTF message in an NFC Controller Interface (NCI) protocol. When the first terminal device enters the RF field, the first terminal device can detect according to the identification message such as the RF_FIELD_INFO_NTF message whether the first terminal device leaves the RF field within a preset time. The RF_FIELD_INFO_NTF message is a standard message specified in the NCI protocol. The RF_FIELD_INFO_NTF message is more accurate and reliable in detecting whether the first terminal device enters or leaves the RF field.

At step 103, the payment record is sent to a second terminal device.

In an implementation, after reading the payment record of the RF card, the first terminal device may send the acquired payment record of the RF card to the second terminal device for viewing on the second terminal device.

In an example, after acquiring the payment record of the RF card, the first terminal device may send the acquired payment record of the RF card to the second terminal device in the form of a Short Messaging Service (SMS) message according to a phone number of the second terminal device, for viewing on the second terminal device.

In an example, after acquiring the payment record of the RF card, the first terminal device may notify a pre-developed payment query application, such that the payment query application sends the acquired payment record of the RF card to the registered second terminal device in the form of an in-application short message.

In an embodiment, after sending the payment record to the second terminal device, the first terminal device may start a new round of monitoring and continue to detect its entry into an RF field.

According to the data processing method and system, the terminal, and the computer-readable storage medium, provided in the present disclosure, a first terminal device has enabled an NFC function, the first terminal device is provided with an RF card, and the RF card is configured for making a payment via an RF field. The first terminal device can detect in real time whether it enters an RF field. If the first terminal device detects that it enters an RF field and leaves the RF field within a preset time, the first terminal device may read the RF card provided therein to acquire a payment record of the RF card. After acquiring the payment record of the RF card, the first terminal device may send the payment record of the RF card to a second terminal device, for viewing on the second terminal device. When the first terminal device cannot simulate the RF card, the holder of the first terminal device has to use the RF card for payment. Because there is a delay in data processing, i.e., updating of the payment record, the holder of the second terminal device cannot monitor in real time the payment of the holder of the first terminal device. In this embodiment, with the arrangement of the RF card in the first terminal device, when the first terminal device detects that it enters an RF field and leaves the RF field within a preset time, the first terminal device determines that a payment event occurs. In this case, the first terminal device reads the RF card to acquire the payment record of the RF card, and sends the payment record to the second terminal device in real time. In this way, the user, i.e., the holder of the second terminal device, can monitor in real time the payments made by the holder of the first terminal device who is an elderly person or child, thereby improving use experience of the user.

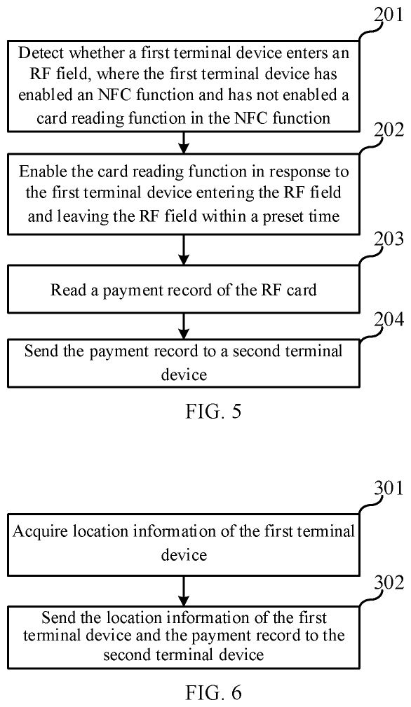

Another embodiment of the present disclosure relates to a data processing method. Implementation details of the data processing method of this embodiment will be described below and the following contents are provided only for convenience of understanding and are not necessary for implementing the present scheme. FIG. 5 is a flowchart of the data processing method of this embodiment, including the following steps 201 to 204.

At step 201, it is detected whether a first terminal device enters an RF field, where the first terminal device has enabled an NFC function and has not enabled a card reading function in the NFC function.

At step 202, the card reading function is enabled when the first terminal device enters the RF field and leaves the RF field within a preset time.

In an implementation, the NFC function of the first terminal device is enabled all the time, but the first terminal device does not enable the card reading function in the NFC function before leaving the RF field. When the first terminal device determines that it enters the RF field and leaves the RF field within the preset time, the first terminal device enables the card reading function in the NFC function.

In an embodiment, considering that the first terminal device generates an RF field after enabling the card reading function in the NFC function, if the first terminal device enters an RF field generated by a device such as a subway automatic gate machine, a bus card reader, or a POS machine, it means that the RF card arranged in the first terminal device is in two RF fields at the same time. In this case, the first terminal device may fail to read the RF card, and a payment made by the RF card may also fail. Therefore, in this embodiment, the NFC function is refined, and the card reading function in the NFC function is enabled only after the first terminal device leaves the RF field, to ensure that the RF card enters only one RF field at a time, and prevent the payment failure caused by interference in the payment process of the RF card.

At step 203, a payment record of the RF card is read.

Step 203 is substantially the same as step 102, so the details will not be repeated herein.

At step 204, the payment record is sent to a second terminal device.

In an embodiment, after sending the payment record to the second terminal device, the first terminal device may disable the card reading function in the NFC function to ensure that the first terminal device does not generate an RF field. In this way, when the first terminal device enters an RF field next time, the RF card enters only an RF field generated by a device such as a subway automatic gate machine, a bus card reader, or a POS machine, thereby ensuring that the RF card can smoothly perform a payment activity.

In this embodiment, before the first terminal device leaves the RF field, the first terminal device does not enable the card reading function in the NFC function; and reading a payment record of the RF card when the first terminal device enters the RF field and leaves the RF field within a preset time includes: enabling the card reading function when the first terminal device enters the RF field and leaves the RF field within the preset time; and reading the payment record of the RF card. By default, the first terminal device does not enable the card reading function. Only when the first terminal device detects that it enters an RF field and leaves the RF field within the preset time, the first terminal device enables the card reading function to read the payment record of the RF card. This can effectively prevent the RF field of the first terminal device from interfering with the payment of the RF card and ensure the normal payment of the RF card.

In another embodiment, the holder of the second terminal device may monitor the location of the holder of the first terminal device in real time by performing steps 301 to 302 shown in FIG. 6.

At step 301, location information of the first terminal device is acquired.

At step 302, the location information of the first terminal device and the payment record are sent to the second terminal device.

In an implementation, after reading the payment record of the RF card, the first terminal device may enable a positioning function, acquire a real-time location of the first terminal device, generate location information of the first terminal device, and send the location information of the first terminal device and the payment record to the second terminal device, for viewing on the second terminal device.

In an embodiment, the user not only cares about payments made by the elderly person or child, but also cares more about where the elderly person or child makes the payments. For example, the first terminal device is held by a student, and a payment record is purchase of instant noodles. Purchase of instant noodles from a school supermarket and purchase of instant noodles from an Internet café are of different importance to the user. Therefore, in this embodiment, the first terminal device may acquire the location of the first terminal device in real time after acquiring the payment record, and send the location information of the first terminal device and the payment record to the second terminal device, for the user to monitor where the holder of the first terminal device makes the payment, to better meet usage demands of the user.

In an example, after acquiring the location information of the first terminal device, the first terminal device may carry the location information of the first terminal device in the payment record. In this case, the sending of the payment record by the first terminal device to the second terminal device for viewing on the second terminal device means that the location information of the first terminal device is sent to the second terminal device for viewing on the second terminal device. In some scenarios, the payment record of the RF card already carries location information. For example, in the case of subway ride consumption, the payment record may show that the first terminal device enters at Station A and exits at Station B. In this case, the location information of the first terminal device is carried in the payment record, and the first terminal device may only need to send the payment record to the second terminal device, thereby reducing the amount of data exchanged to better meet usage demands of the user.

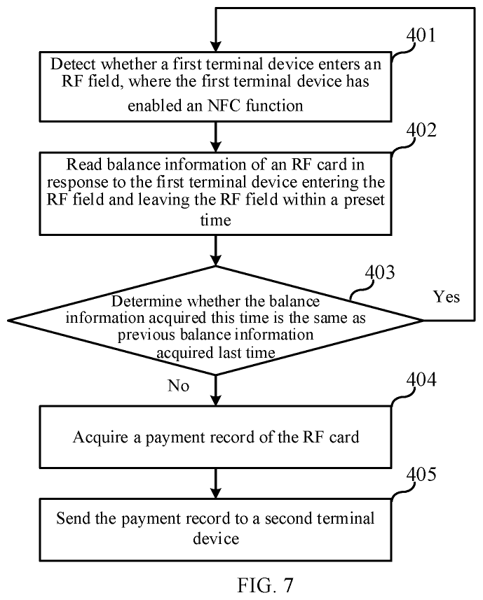

Another embodiment of the present disclosure relates to a data processing method. Implementation details of the data processing method of this embodiment will be described below and the following contents are provided only for convenience of understanding and are not necessary for implementing the present scheme. FIG. 7 is a flowchart of the data processing method of this embodiment, including the following steps 401 to 405.

At step 401, it is detected whether a first terminal device enters an RF field, where the first terminal device has enabled an NFC function.

Step 401 is substantially the same as step 101, so the details will not be repeated herein.

At step 402, balance information of an RF card is read when the first terminal device enters the RF field and leaves the RF field within a preset time.

In an implementation, when the first terminal device detects that it enters the RF field and leaves the RF field within the preset time, the first terminal device may read the balance information of the RF card. The balance information may represent an account balance in the RF card.

At step 403, it is determined whether the balance information acquired this time is the same as previous balance information acquired last time. If yes, step 401 is executed; otherwise, step 404 is executed.

At step 404, a payment record of the RF card is acquired.

In an embodiment, after acquiring the balance information of the RF card, the first terminal device can determine whether the balance information acquired this time is the same as the previous balance information acquired last time. If the balance information acquired this time is different from the previous balance information acquired last time, it indicates that the RF card has made a payment, and the first terminal device can acquire the payment record of the RF card.

In an example, the first terminal device determines that the balance information acquired this time is the same as the previous balance information acquired last time, indicating that the RF card, though having entered the RF field, has not made a payment. In this case, the first terminal device may do not need to acquire the payment record, and the first terminal device exits the current payment query process, and performs a next round of monitoring to continue to detect whether the first terminal device enters an RF field.

At step 405, the payment record is sent to a second terminal device.

Step 405 is substantially the same as step 103, so the details will not be repeated herein.

In this embodiment, acquiring a payment record of the RF card includes: reading the RF card and acquiring balance information of the RF card; and when the balance information is the same as previous balance information acquired last time, determining that no payment has been made using the RF card, and detecting again whether the first terminal device enters the RF field; or when the balance information is different from the previous balance information acquired last time, acquiring the payment record of the RF card. When the first terminal device detects that it enters an RF field and leaves the RF field within a preset time, the first terminal device may perform second detection to detect whether the balance of the RF card changes. If the balance does not change, it indicates that the RF card has not made a payment, and the first terminal device re-detects whether the first terminal device enters an RF field. If the balance changes, it indicates that the RF card has made a payment, and the first terminal device acquires the payment record of the RF card. This can effectively prevent the first terminal device from sending useless blank payment records to the second terminal device, thereby reducing unnecessary information exchange and saving communication resources.

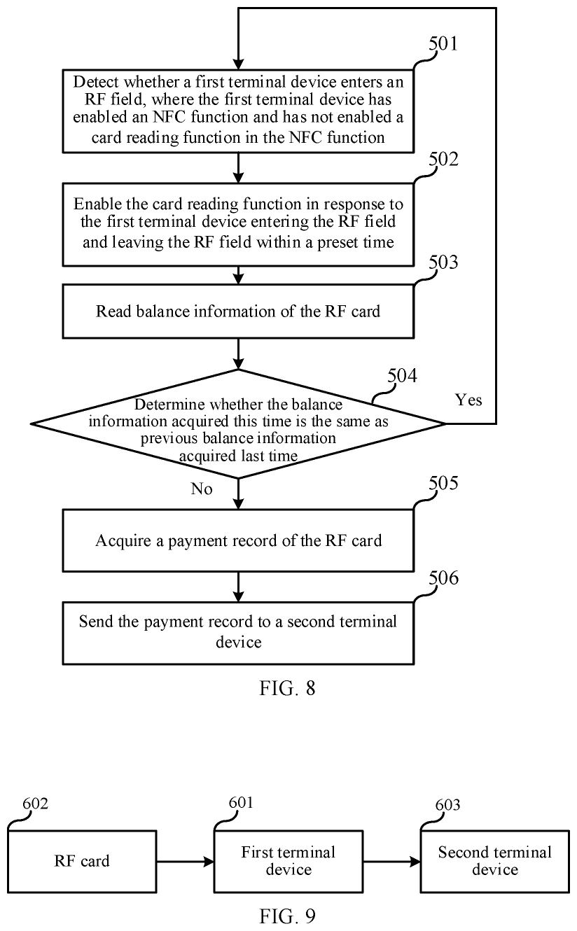

Another embodiment of the present disclosure relates to a data processing method. Implementation details of the data processing method of this embodiment will be described below and the following contents are provided only for convenience of understanding and are not necessary for implementing the present scheme. FIG. 8 is a flowchart of the data processing method of this embodiment, including the following steps 501 to 506.

At step 501, it is detected whether a first terminal device enters an RF field, where the first terminal device has enabled an NFC function and has not enabled a card reading function in the NFC function.

At step 502, the card reading function is enabled when the first terminal device enters the RF field and leaves the RF field within a preset time.

At step 503, balance information of the RF card is read.

At step 504, it is determined whether the balance information acquired this time is the same as previous balance information acquired last time. If yes, step 501 is executed; otherwise, step 505 is executed.

At step 505, a payment record of the RF card is acquired.

At step 506, the payment record is sent to a second terminal device.

Another embodiment of the present disclosure relates to a data processing system. Details of the data processing system of this embodiment will be described below and the following contents are provided only for convenience of understanding and are not necessary for implementing this embodiment. FIG. 9 is a schematic diagram of the data processing system of this embodiment, which includes a first terminal device 601, an RF card 602, and a second terminal device 603. The first terminal device 601 is provided with the RF card 602.

The first terminal device 601 is configured for detecting whether the first terminal device 601 enters an RF field, reading a payment record of the RF card 602 when the first terminal device 601 enters the RF field and leaves the RF field within a preset time, and sending the payment record to the second terminal device 603.

The RF card 602 is configured for performing a payment via the RF field when the first terminal device 601 enters the RF field and leaves the RF field within the preset time.

The second terminal device 603 is configured for receiving the payment record sent by the first terminal device 601.

It can be seen that this embodiment is a system embodiment corresponding to the foregoing method embodiments, and this embodiment may be implemented in combination with the foregoing method embodiments. The related technical details and technical effects mentioned in the foregoing method embodiments are still valid in this embodiment, and the details will not be repeated herein in order to reduce repetition. Correspondingly, the related technical details mentioned in this embodiment are also applicable to the above embodiments.

It is to be noted that each module involved in this embodiment is a logic module. In practical applications, a logic unit may be a physical unit or a part of a physical unit, or may be implemented by a combination of a plurality of physical units. In addition, in order to highlight the innovative part of the present application, units that are not closely related to the technical problem to be solved in the present application are not introduced in this embodiment, but this does not mean that there are no other units in this embodiment.

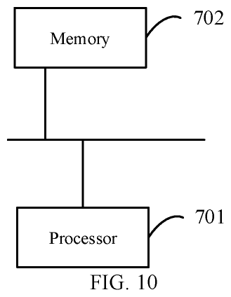

Another embodiment of the present disclosure relates to a terminal device. As shown in FIG. 10, the terminal device includes: at least one processor 701; and a memory 702 communicably connected to the at least one processor 701. The memory 702 stores instructions executable by the at least one processor 701 which, when executed by the at least one processor 701, causes the at least one processor 701 to implement the data processing method according to the foregoing method embodiments.

The memory and the processor are connected by a bus. The bus may include any number of interconnected buses and bridges. The bus connects various circuits of one or more processors and the memory together. The bus may also connect together a peripheral device, a voltage regulator, a power management circuit, and other circuits, which are all well known in the art and therefore will not be detailed herein. A bus interface provides an interface between the bus and a transceiver. The transceiver may be one element or a plurality of elements, for example, a plurality of receivers and transmitters, and provides a unit for communicating with various other apparatus over a transmission medium. Data processed by the processor is transmitted over a wireless medium through an antenna. The antenna further receives data and transmits the data to the processor.

The processor is responsible for managing the bus and general processing and may also provide various functions including timing, peripheral interfaces, voltage regulation, power management and other control functions. The memory may be configured to store data used by the processor in performing operations.

Another embodiment of the present disclosure relates to a computer-readable storage medium, storing a computer program which, when executed by a processor, causes the processor to implement the foregoing method embodiments.

It may be understood by those having ordinary skills in the art that all or some of the steps of the methods in the above embodiments may be performed by a program instructing related hardware. The program is stored in a storage medium, and includes several instructions to cause a device (which may be a single chip microcomputer, a chip, etc.) or a processor to perform all or some of the steps of the methods described in the embodiments of the present application. The foregoing storage medium includes: any medium that can store program code, such as a Universal Serial Bus (USB) flash drive, a removable hard disk, a Read-Only Memory (ROM), a Random Access Memory (RAM), a magnetic disk, or an optical disk.

According to the data processing method provided in the present disclosure, a first terminal device has enabled an NFC function, the first terminal device is provided with an RF card, and the RF card is configured for making a payment via an RF field. The first terminal device may detect in real time whether it enters an RF field. If the first terminal device detects that it enters an RF field and leaves the RF field within a preset time, the first terminal device may read a payment record of the RF card provided therein. After acquiring the payment record of the RF card, the first terminal device may send the payment record of the RF card to a second terminal device, for viewing on the second terminal device. When the first terminal device cannot simulate the RF card, the holder of the first terminal device has to use the RF card for payment. Because there is a delay in data processing, i.e., updating of the payment record, the holder of the second terminal device cannot monitor in real time the payment of the holder of the first terminal device. In this embodiment, with the arrangement of the RF card in the first terminal device, when the first terminal device detects that it enters an RF field and leaves the RF field within a preset time, the first terminal device determines that a payment event occurs. In this case, the first terminal device reads the payment record of the RF card, and sends the payment record to the second terminal device in real time. In this way, the user, i.e., the holder of the second terminal device, can monitor in real time the payments made by the holder of the first terminal device who is an elderly person or child, thereby improving use experience of the user.

It may be understood by those having ordinary skills in the art that the foregoing embodiments are some embodiments for practicing the present application and that in practical applications, various changes in form and details may be made without departing from the scope of the present disclosure.

1. A data processing method, applied to a first terminal device, the method comprising:
detecting whether a first terminal device enters a Radio Frequency (RF) field, wherein the first terminal device has enabled a Near Field Communication (NFC) function, the first terminal device is provided with an RF card, and the RF card is configured for making a payment via the RF field;
reading a payment record of the RF card in response to the first terminal device entering the RF field and leaving the RF field within a preset time; and
sending the payment record to a second terminal device.

2. The data processing method of claim 1, wherein before the first terminal device leaves the RF field, the first terminal device does not enable a card reading function in the NFC function; and
reading a payment record of the RF card in response to the first terminal device entering the RF field and leaving the RF field within a preset time comprises:
enabling the card reading function in response to the first terminal device entering the RF field and leaving the RF field within the preset time; and
reading the payment record of the RF card.

3. The data processing method of claim 1, wherein after reading the payment record of the RF card, the method comprises:
acquiring location information of the first terminal device; and
sending the payment record to a second terminal device comprises:
sending the location information of the first terminal device and the payment record to the second terminal device.

4. The data processing method of claim 3, wherein sending the location information of the first terminal device and the payment record to the second terminal device comprises:
carrying the location information of the first terminal device in the payment record.

5. The data processing method of claim 1, wherein reading the payment record of the RF card comprises:
reading the RF card and acquiring balance information of the RF card; and
in response to the balance information being the same as previous balance information acquired last time, determining that no payment has been made using the RF card, and detecting again whether the first terminal device enters the RF field; or
in response to the balance information being different from the previous balance information acquired last time, acquiring the payment record of the RF card.

6. The data processing method of claim 1, wherein that the first terminal device is provided with an RF card comprises:
a card slot is provided on an inner side or an outer side of a back housing of the first terminal device, and the card slot is configured for fixing the RF card.

7. The data processing method of claim 1, wherein detecting whether a first terminal device enters an RF field comprises:
detecting according to an identification message whether the first terminal device enters the RF field, wherein the identification message at least comprises an RF_FIELD_INFO_NTF message; and
detecting whether the first terminal device leaves the RF field within the preset time comprises:
detecting according to the identification message whether the first terminal device leaves the RF field within the preset time.

8. A data processing system, comprising a first terminal device, a Radio Frequency (RF) card, and a second terminal device, wherein the first terminal device is provided with the RF card;
the first terminal device is configured for detecting whether the first terminal device enters an RF field, reading a payment record of the RF card in response to the first terminal device entering the RF field and leaving the RF field within a preset time, and sending the payment record to the second terminal device;
the RF card is configured for making a payment via the RF field in response to the first terminal device entering the RF field and leaving the RF field within the preset time; and
the second terminal device is configured for receiving the payment record sent by the first terminal device.

9. A terminal device, comprising:
at least one processor; and
a memory communicably connected to the at least one processor, wherein:
the memory stores instructions executable by the at least one processor which, when executed by the at least one processor, causes the at least one processor to carry out the data processing method of claim 1.

10. A non-transitory computer-readable storage medium, storing a computer program which, when executed by a processor, causes the processor to carry out the data processing method of claim 1.

11. The data processing method of claim 2, wherein reading the payment record of the RF card comprises:
reading the RF card and acquiring balance information of the RF card; and
in response to the balance information being the same as previous balance information acquired last time, determining that no payment has been made using the RF card, and detecting again whether the first terminal device enters the RF field; or
in response to the balance information being different from the previous balance information acquired last time, acquiring the payment record of the RF card.

12. The data processing method of claim 3, wherein reading the payment record of the RF card comprises:
reading the RF card and acquiring balance information of the RF card; and
in response to the balance information being the same as previous balance information acquired last time, determining that no payment has been made using the RF card, and detecting again whether the first terminal device enters the RF field; or
in response to the balance information being different from the previous balance information acquired last time, acquiring the payment record of the RF card.

13. The data processing method of claim 4, wherein reading the payment record of the RF card comprises:
reading the RF card and acquiring balance information of the RF card; and
in response to the balance information being the same as previous balance information acquired last time, determining that no payment has been made using the RF card, and detecting again whether the first terminal device enters the RF field; or
in response to the balance information being different from the previous balance information acquired last time, acquiring the payment record of the RF card.

14. The data processing method of claim 2, wherein detecting whether a first terminal device enters an RF field comprises:
detecting according to an identification message whether the first terminal device enters the RF field, wherein the identification message at least comprises an RF_FIELD_INFO_NTF message; and
detecting whether the first terminal device leaves the RF field within the preset time comprises:
detecting according to the identification message whether the first terminal device leaves the RF field within the preset time.

15. The data processing method of claim 3, wherein detecting whether a first terminal device enters an RF field comprises:
detecting according to an identification message whether the first terminal device enters the RF field, wherein the identification message at least comprises an RF_FIELD_INFO_NTF message; and
detecting whether the first terminal device leaves the RF field within the preset time comprises:
detecting according to the identification message whether the first terminal device leaves the RF field within the preset time.

16. The data processing method of claim 4, wherein detecting whether a first terminal device enters an RF field comprises:
detecting according to an identification message whether the first terminal device enters the RF field, wherein the identification message at least comprises an RF_FIELD_INFO_NTF message; and
detecting whether the first terminal device leaves the RF field within the preset time comprises:
detecting according to the identification message whether the first terminal device leaves the RF field within the preset time.
